(19) United States
(12) Patent Application Publication
(10) Pub. No.: US 2017/0259392 A1
(43) Pub. Date: Sep. 14, 2017

(54) METAL FINISHING ROTARY TOOL

(71) Applicant: Easthill Group, Inc., Pottstown, PA (US)

(72) Inventor: Mark A. ROBIDOUX, Coatesville, PA (US)

(21) Appl. No.: 15/454,694

(22) Filed: Mar. 9, 2017

Related U.S. Application Data
(60) Provisional application No. 62/306,335, filed on Mar. 10, 2016.

(51) Int. Cl. B24B 23/02; B24B 55/05; B25F 5/02

(52) U.S. Cl. CPC B24B 23/02; B25F 5/025; B24B 55/052

(57) ABSTRACT

The present disclosure relates to a metal finishing tool comprising a tool body having a handle section, a motor housing, and an L-shaped support arm that extends laterally from the motor housing to an elbow and longitudinally from the elbow to an arm end. The metal finishing tool further includes a motor and a drive train located within the tool body that are operatively coupled to drive a spindle and rotatable drum, which are coupled to the support arm. The spindle extends from a spindle base proximate to the arm end of the support arm to a spindle end that is free, and the spindle's axis intersects the motor axis of the tool body. The spindle and drum are balanced across the motor axis of the tool, thereby minimizing any torque load exerted by the rotating drum when the tool is in use.

### BACKGROUND

Metal finishing tools are commonly used in multiple industries to strip, polish, clean, and otherwise prepare metal surfaces for finishing. Current tools utilize abrasive wheels for paint removal without damaging metal finishes, abrasive paper bands for corrosion removal or for use on areas of polyester body fillers, and abrasive bands to remove coatings from wood surfaces such as wooden decks, railings, stairs, etc.

Current tool designs on the market have a rotating drum off-set to the left or right of the drive motor. The off-set design offers ease of manufacturing but leads to user fatigue as the spindle, during operation, applies a torque load (gyroscopic precession) to the motor housing/handle assembly. This loading requires the user to constantly apply a counter force to the torque load. After extended periods of operation the user experiences hand and wrist fatigue. The offset design also positions the rotating drum out-of-line of the operator, requiring additional time and attention to properly align the drum or drive wheel.

### SUMMARY

In view of the foregoing background, a metal finishing tool is disclosed. The metal finishing tool comprises a tool body having a proximal end, a distal end, and a motor axis, wherein the proximal end defines a handle section and the distal end defines a motor housing. The tool body further includes a support arm that extends laterally from the distal end to an elbow located on one side of the motor axis and longitudinally from the elbow to an arm end. A motor is located within the motor housing and a drive train is located within the support arm, and the motor and drive train are operatively coupled.

The metal finishing tool further includes a spindle coupled to the support arm and operatively coupled to the drive train. The spindle extends from a spindle base located proximate to the arm end of the support arm to a spindle end that is free and has a spindle axis that overlaps the motor axis. The spindle also includes a rotatable drum extending from a first drum end located proximate to the spindle base to a second drum end located proximate to the spindle end. The vertical plane of the motor axis intersects the drum at a location between the first drum end and the second drum end, thereby “balancing” the drum across the motor axis.

### BRIEF DESCRIPTION OF THE DRAWINGS

For a more complete understanding of the present invention, reference is made to the following detailed description of an embodiment considered in conjunction with the accompanying drawings, in which:

FIG. 1 is a perspective view of a metal finishing tool constructed in accordance with an embodiment of the present invention;

FIG. 2 is an overhead view of the metal finishing tool shown in FIG. 1;

FIG. 3 is a side elevational view of the metal finishing tool shown in FIG. 1;

FIG. 4 is a perspective view of the spindle, drive train, and motor of the metal finishing tool shown in FIG. 1;

FIG. 5 is a perspective view of the spindle, drive train, and motor shown in FIG. 4 with the motor in an exploded position;

FIG. 6 is a side elevational view of the spindle, drive train, and motor shown in FIG. 4; and

FIG. 7 is a top plan view of the spindle, drive train, and motor shown in FIG. 4.

### DETAILED DESCRIPTION OF THE INVENTION

The following disclosure is presented to provide an illustration of the general principles of the present invention and is not meant to limit, in any way, the inventive concepts contained herein. Moreover, the particular features described in this section can be used in combination with the other described features in each of the multitude of possible permutations and combinations contained herein.

All terms defined herein should be afforded their broadest possible interpretation, including any implied meanings as dictated by a reading of the specification as well as any words that a person having skill in the art and/or a dictionary, treatise, or similar authority would assign particular meaning. Further, it should be noted that, as recited in the specification and in the claims appended hereto, the singular forms “a,” “an,” and “the” include the plural referents unless otherwise stated. Additionally, the terms “comprises” and “comprising” when used herein specify that certain features are present in that embodiment, but should not be interpreted to preclude the presence or addition of additional features, components, operations, and/or groups thereof.

The following disclosure is intended to be read in connection with the accompanying drawings, which are to be considered part of the entire written description of the invention. The drawing figures are not necessarily to scale and certain features of the invention may be shown exaggerated in scale or in somewhat schematic form in the interest of clarity and conciseness. In this description, relative terms such as “horizontal,” “vertical,” “up,” “down,” “top,” “bottom,” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both moveable or rigid attachments or relationships, unless expressly described otherwise, and includes terms such as “directly” coupled, secured, etc. The term “operatively coupled” is such an attachment, coupling, or connection that allows the pertinent structures to operate as intended by virtue of that relationship.

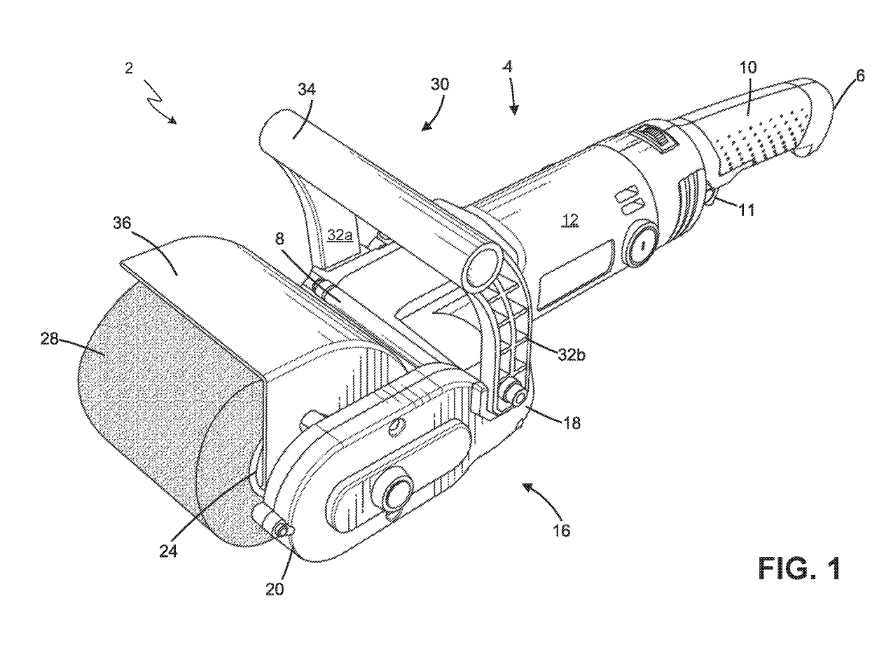

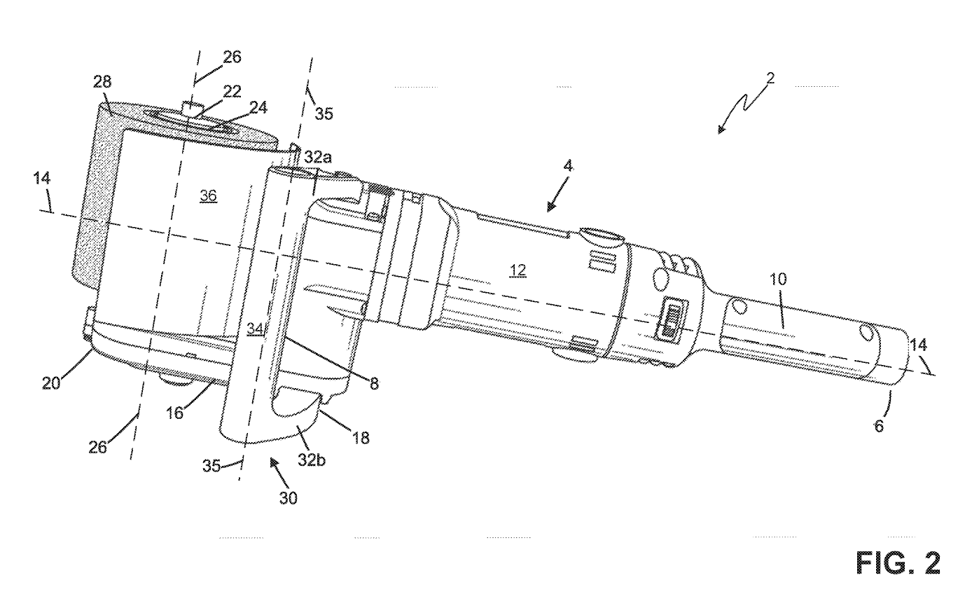

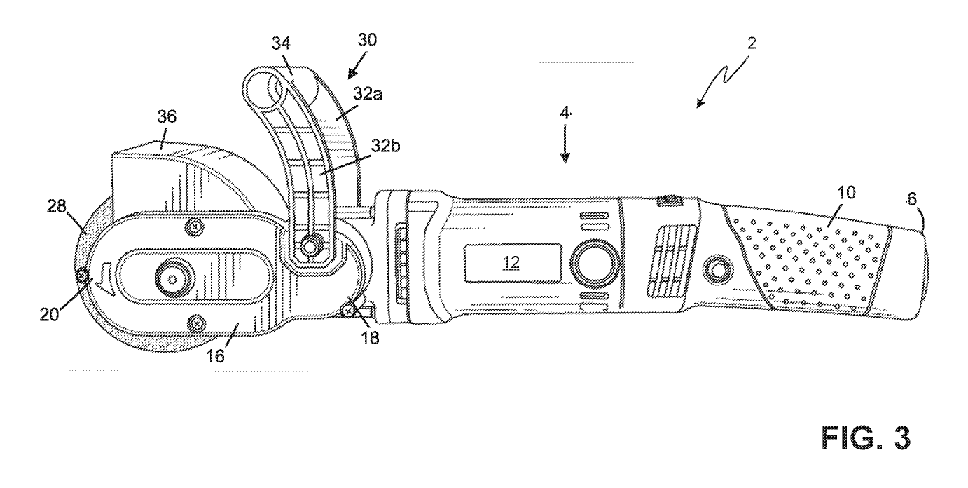

Turning now to FIGS. 1-3, one embodiment of a metal finishing tool 2 is disclosed. The metal finishing tool 2 includes a tool body 4 having a proximal end 6 and a distal end 8. The proximal end 6 of the tool body 4 is sized and shaped to define a handle section 10 that is suitable to be gripped by a user and includes a tool switch 11 that is configured to turn the metal finishing tool 2 “on” (i.e., connect electrical power to the metal finishing tool 2). The tool body 4 includes a motor housing 12 located between the handle section 10 and the distal end 8 that is sized and shaped to house a motor (not shown) having a motor axis 14. The motor housing 12 and the handle section 10 have a linear arrangement and are coaxially aligned with the motor axis 14.

The tool body 4 further includes a support arm 16 having an L-shape that extends laterally from the distal end 8 to an offset elbow 18 and longitudinally from the elbow 18 to an arm end 20. A spindle 22 is coupled to the support arm 16 and includes a rotatable drum 24 that is cylindrical and rotates about the axis of the spindle 22 (i.e., the spindle axis 26). The spindle axis 26 overlaps the motor axis 14 and the drum 24 is positioned such that it is in-line with the handle section 10 and the motor housing 12 and “balanced” across the motor axis 14, as will be discussed in further detail below. The support arm 16 is sized and shaped to house a drive train (not shown) that is operatively coupled to both the motor at one end and the drum 24 at the other, thereby allowing the motor's rotary motion to drive the rotation of the drum 24.

In this disclosure, the term “vertical” refers to the direction that is orthogonal to the motor axis 14 and the spindle axis 26. Accordingly, the “vertical plane” of the motor axis 14 refers to the plane created by the motor axis 14 and the vertical vector that is orthogonal to the motor axis 14 and the spindle axis 26. In addition, the term “lateral” refers to a direction that is orthogonal to the motor axis 14, while “longitudinal” refers to a direction that is parallel to the motor axis 14.

In one embodiment, the drum 24 is sized and shaped to receive a finishing accessory 28 thereon, and the spindle axis 26 is spaced a distance c away from the distal end 8 that is sufficient to allow the finishing accessory 28 to not make contact with the tool body 4 when in use. The finishing accessory 28 can be configured to provide any one of a number of functions, including, but not limited to, stripping, grinding, polishing, and sanding. In one embodiment, the finishing accessory 28 is releasably coupled to the drum 24 by a friction fit. Examples of a finishing accessory 28 suitable to be fit on the drum 24 include a sanding drum attachment having a 3.5″ diameter×4.0″ length, a polishing drum attachment having a 4.0″ diameter×4.0″ length, and/or any other suitable releasable attachment and dimensional size (length and/or diameter).

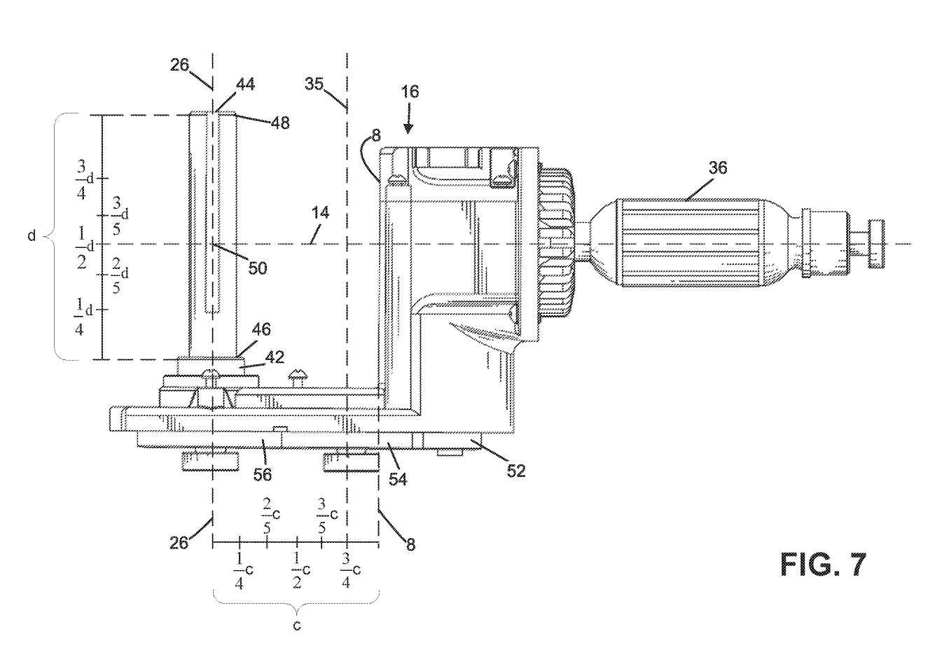

Still referring to FIGS. 1-3, in one embodiment, the metal finishing tool 2 includes an overhead handle 30 attached to the tool body 4 for allowing a user to grip the metal finishing tool 2 at a location closer to the drum 24 to enable better control over the metal finishing tool 2 during use. The overhead handle 30 includes a pair of struts 32a, 32b that extend upwardly from the support arm 16 of the tool body 4 and a crossbar 34 that extends between the two struts 32a, 32b and overlaps the motor axis 14. The crossbar 34 has a crossbar axis 35 and is positioned above and proximal to the distal end 8 of the tool body 4 and longitudinally away from the spindle axis 26 in the direction of the distal end 8. In one embodiment, as seen in FIG. 7, the crossbar 34 is positioned a longitudinal distance away from the spindle axis 26 such that the crossbar axis 35 is at least 60% of the distance between the spindle axis 26 and the distal end 8 (i.e., at least ⅗c away from the spindle axis 26). In another embodiment, the crossbar 34 is positioned such that the crossbar axis 35 is at least 75% of the distance between the spindle axis 26 and the distal end 8 (i.e, at least ¾c away from the spindle axis 26). In a preferred embodiment, the crossbar 34 is positioned directly above the distal end 8 of the tool body 4 such that the crossbar axis 35 is vertically aligned with the distal end 8 (i.e., the crossbar axis 35 is at least the longitudinal distance c away from the spindle axis 26). The overhead handle 30 is designed to be gripped by a user, along with the handle section 10, so that the user's hands substantially overlap the motor axis 14 to reduce the need for the user to apply rotational torque force in order to control the metal finishing tool 2 when in use. Further, the positioning of the crossbar 34 allows the user's hands to be likewise positioned away from the drum 24 and any finishing accessory 28 thereon, thereby improving the user's safety.

In one embodiment, the metal finishing tool 2 includes a drum shield 36 that is sized and shaped to cover a portion of a finishing accessory 28 that has been fitted on the drum 24 while not touching the finishing accessory 28. The drum shield 36 protects the user's hand which is gripping the overhead handle 30 from accidentally coming into contact with a rotating finishing accessory 28 while the metal finishing tool 2 is in use. In this regard, the positioning of the overhead handle 30 enables the drum shield 36 to cover only a small portion of the finishing accessory 28 (i.e., between ¼ and ½ of the surface area of the finishing accessory 28) in order to adequately protect the user's hand gripping the overhead handle 30. This allows the user greater freedom to position the metal finishing tool 2 over prior art devices because the finishing accessory 28 has a more usable surface area. In one embodiment, the drum shield 36 is formed integrally with the spindle 22. In another embodiment, the drum shield 36 is removable.

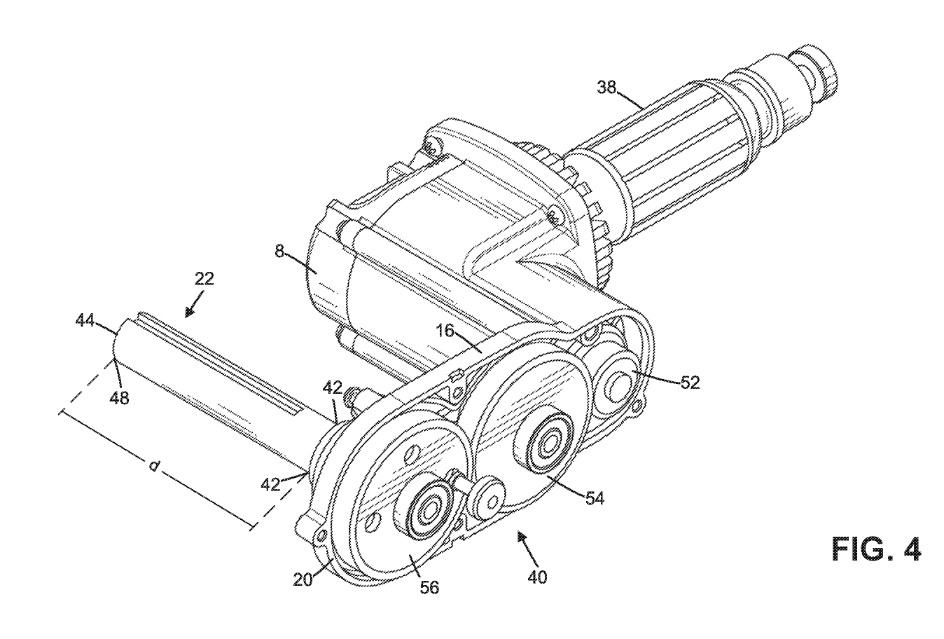

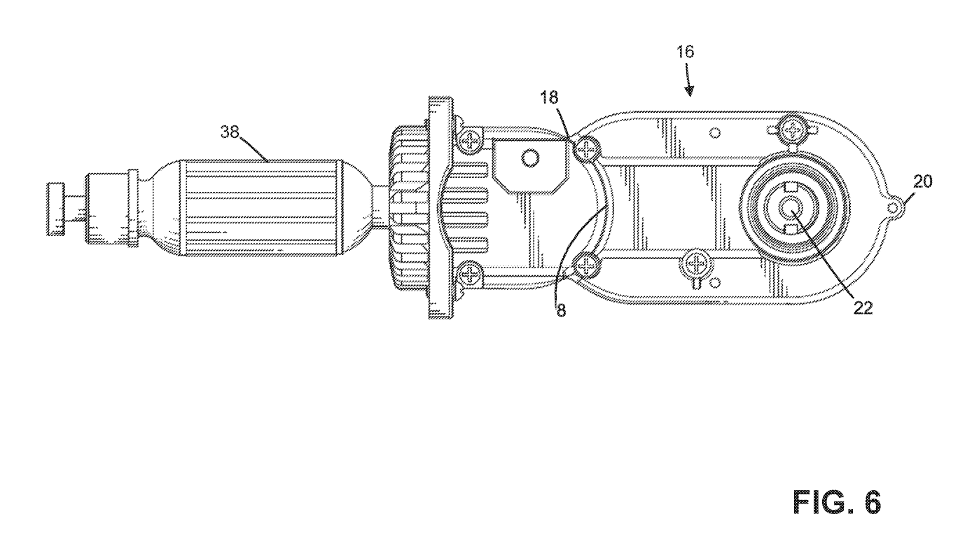

Referring now to FIGS. 4-7, the metal finishing tool 2 includes a motor 38 and a drive train 40 that are operably coupled to drive the rotation of the drum 24. As discussed above, the motor 38 is housed in the motor housing 12 and has a motor axis 14, and the drive train 40 is housed in the support arm 16.

In one embodiment, the motor 38 comprises a variable speed motor having one or more speed settings. A speed setting can be correlated with a predetermined number of rotations per minute (RPM) of the motor. In one embodiment, the motor 38 is a variable speed motor configured to switch between a first speed (e.g. “low speed”) having a first RPM and a second speed (e.g., “high speed”) having a second RPM, where the second RPM value is higher than the first RPM value. For example, in one embodiment, the first RPM value is 1600 RPM and the second RPM value is 2900 RPM. In other embodiments, the variable speed motor can include a progressive control that allows the variable speed motor to have any RPM value within a range of RPM values.

As seen in FIGS. 4 and 7, the spindle 22 is coupled to the support arm 16 at a spindle base 42 located proximate to the arm end 20. The spindle 22 extends perpendicular to the support arm 16 from the spindle base 42 to a spindle end 44, which is the free end of the spindle 22 distal from the support arm 16. The drum 24 of the spindle 22 extends across the spindle 22 from a first drum end 46, which is proximate to the spindle base 42, to a second drum end 48, which is proximate to the spindle end 44. In one embodiment, the first drum end 46 is flush with the spindle base 42 and the second drum end 48 is flush with the spindle end 44, resulting in a drum 24 having a length d that is substantially equal to the length of the spindle 22. In another embodiment, the first drum end 46 is spaced inwardly from the spindle base 42 and the second drum end 48 is spaced inwardly from the spindle end 44, resulting in a drum 24 having a length d that is shorter than the length of the spindle 22. In yet another embodiment, the first drum end 46 is flush with the spindle base 42 and the second drum end 48 extends beyond the spindle end 44, resulting in a drum 24 having a length d that is longer than the length of the spindle 22.

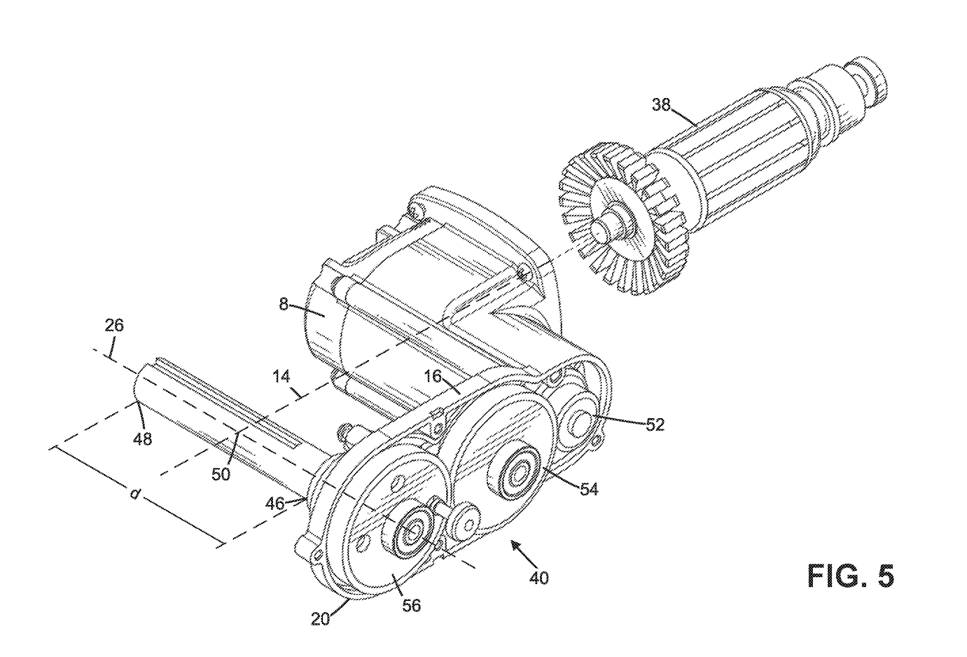

Referring now to FIGS. 5 and 7, the vertical plane of the motor axis 14 intersects the spindle 22 and the drum 24 at an intersection area 50 located between the first drum end 46 and the second drum end 48. This enables the drum 24 to be substantially “balanced” across the motor axis 14, as a portion of the drum 24 is located on one side of the vertical plane of the motor axis 14, and the other portion of the drum 24 is located on the other side of the vertical plane of the motor axis 14. This puts the spindle 22 midpoint in line with the motor housing 12 and the handle section 10, thereby balancing the torque load applied by the finishing accessory 28 when in use to the tool body 4 and minimizing the need for a user to apply a counter force to the torque load. This results in less hand and wrist fatigue experienced by the user when using the metal finishing tool 2.

In one embodiment, the intersection area 50 is located in the middle 50% of the drum 24 (i.e., between ¼d and ¾d). In another embodiment, the intersection area 50 is located in the middle 20% of the drum 24 (i.e., between ⅖d and ⅗d). In another embodiment, the intersection area 50 is located at the true middle of the drum 24 (i.e., the first drum end 46 and the second drum end 48 are equidistant from the intersection area 50). The closer the intersection area 50 is to the true middle of the drum 24, the more balanced the drum 24 is relative to the motor axis 14.

In one embodiment, the drive train 40 comprises a plurality of gears that enable the motor 38 to drive the drum 24 on the spindle 22. FIG. 4 illustrates such an embodiment wherein the motor 38 is coupled to the drum 24 by an armature gear 52, a first transfer gear 54, and a second transfer gear 56. The armature gear 52 is coupled to a drive shaft (not shown) of the motor 38 and rotates the armature gear 52, which is coupled to and rotates the first transfer gear 54. The first transfer gear 54 can have a larger, smaller, and/or equal gear ratio to the armature gear 52. In one embodiment, the first transfer gear 54 is operatively coupled to a second transfer gear 56. The second transfer gear 56 can have a larger, smaller, and/or equal gear ratio to the armature gear 52 and/or the first transfer gear 54. Although embodiments having two transfer gears are illustrated herein, it will be appreciated that a greater and/or lesser number of gears can couple the motor 38 to the drum 24. In other embodiments, the drive train 40 can comprise any suitable connection mechanism, including, but not limited to, one or more gears, belts, shafts, and/or any other suitable connection mechanism.

All examples and conditional language recited herein are intended for pedagogical purposes to aid the reader in understanding the principles of the present invention and the concepts contributed by the inventor in furthering the art. As such, they are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It is to be understood that the embodiments described herein are merely exemplary and that a person skilled in the art may make many variations and modifications without departing from the spirit and scope of the invention. All such variations and modifications are intended to be included within the scope of the invention, as defined by the following claims.

I claim:

1. A metal finishing tool, comprising:
a tool body having a proximal end and a distal end, the proximal end defining a handle section and the distal end defining a motor housing;
a motor located within said motor housing and having a motor axis, wherein the handle section and the motor housing are coaxially aligned with the motor axis;
a support arm extending laterally from the distal end to an elbow located on one side of the motor axis and longitudinally from the elbow to an arm end, the support arm housing a drive train that is operatively coupled to the motor; and
a spindle coupled to the support arm and operatively coupled to the drive train, the spindle extending from a spindle base located proximate to the arm end of the support arm to a spindle end that is free and distal to the support arm, the spindle having a spindle axis that laterally overlaps the motor axis, the spindle including a rotatable drum extending from a first drum end located proximate to the spindle base to a second drum end located proximate to the spindle end.

2. The metal finishing tool of claim 1, wherein the support arm extends from the elbow to the arm end in a direction that is parallel to motor axis.

3. The metal finishing tool of claim 1, wherein the spindle and the drum are spaced away from the distal end of the tool body such that a finishing accessory fit onto the drum does not contact the tool body.

4. The metal finishing tool of claim 1, wherein the drive train comprises an armature gear coupled to the motor and at least one transfer gear coupled to the drum, wherein the at least one transfer gear and the armature gear are operatively coupled to allow rotatory motion of the motor to drive rotation of the drum.

5. The metal finishing tool of claim 1, wherein the motor axis has a vertical plane that intersects with the drum at a location between said first drum end and said second drum end.

6. The metal finishing tool of claim 5, wherein the vertical plane of the motor axis intersects the drum at a location within the middle 50% of the drum.

7. The metal finishing tool of claim 5, wherein the vertical plane of the motor axis intersects the drum at a location within the middle 20% of the drum.

8. The metal finishing tool of claim 5, wherein the vertical plane of the motor axis intersects the drum at a location equidistant from the first drum end and the second drum end.

9. The metal finishing tool of claim 1, further comprising an overhead handle that extends across and overlaps the motor axis.

10. The metal finishing tool of claim 9, wherein the overhead handle includes at least one strut attached to the distal end of the tool body and a crossbar connected to the at least one strut, the crossbar being positioned vertically above the distal end of the tool body.

11. The metal finishing tool of claim 10, wherein the crossbar is a longitudinal distance away from the spindle axis that is at least 60% of a distance between the spindle axis and the distal end of the tool body.

12. The metal finishing tool of claim 9, wherein the overhead handle is attached to the support arm.

13. The metal finishing tool of claim 1, further comprising a drum shield attached to the spindle, the drum shield being sized and shaped to cover a portion of a finishing accessory that has been fitted on the drum.

14. A metal finishing tool, comprising:
a tool body having a proximal end and a distal end, the proximal end defining a handle section and the distal end defining a motor housing, the tool body further including a support arm extending from the distal end;
a motor located within the motor housing; and
a spindle coupled to the support arm, the spindle including a rotatable drum, wherein the handle section, the motor, and the rotatable drum are arranged in an in-line configuration.

15. The metal finishing tool of claim 14, further comprising an armature gear coupled to said motor and at least one transfer gear coupled to said rotatable drum, wherein said at least one transfer gear and said armature gear are operatively coupled to transfer rotatory motion of said motor to said rotatable drum.

16. The metal finishing tool of claim 14, wherein said rotatable drum is sized and shaped to receive a finishing accessory thereon.

17. The metal finishing tool of claim 14, wherein said motor includes a variable speed motor having one or more speed settings.
